(19) United States
(12) Patent Application Publication
(10) Pub. No.: US 2009/0297077 A1
(43) Pub. Date: Dec. 3, 2009

(54) Fluid dynamic pressure bearing and production method for the same

(75) Inventors: Katsutoshi Nll, Matsudo-shi (JP); Hideo Shikata, Matsudo-shi (JP); Toshiyasu Katakura, Matsudo-shi (JP)

Correspondence Address: OLIFF & BERRIDGE, PLC, P.O. BOX 320850, ALEXANDRIA, VA, 22320-4850, US

(73) Assignee: Hitachi Powdered Metals Co., Ltd., Matsudo-shi (JP)

(21) Appl. No.: 12/458,582

(22) Filed: Jul. 16, 2009

Related U.S. Application Data
(62) Division of application No. 11/251,904, filed on Oct. 18, 2005.

(30) Foreign Application Priority Data
Oct. 21, 2004 (JP) 2004-306748

(51) Int. Cl. F16C 32/06

(52) U.S. Cl. 384/100

(57) ABSTRACT

A fluid dynamic pressure bearing composed of a cylindrical sintered compact includes: a thrust region which is formed on an end surface of the bearing and receives at least a thrust load; a roughed portion having small peaks and valleys formed on the thrust region; and thrust recesses for generating thrust fluid dynamic pressure, which are formed on the thrust region.

This is a Division of application Ser. No. 11/251,904 filed Oct. 18, 2005. This application claims the benefit of Japanese Patent Application No. 2004-306748, filed Oct. 21, 2004. The disclosures of the prior applications are hereby incorporated by reference herein in their entirety.

### BACKGROUND OF THE INVENTION

1. Field of the Invention

The present invention relates to a fluid dynamic pressure bearing which may be preferably used for spindle motors provided in recording disc drive devices, and relates to a production method for the fluid dynamic pressure bearing.

2. Description of Related Art

For example, in various kinds of information devices such as disc drive devices which read and write information from and to a magnetic disc or an optical disc such a CD or a DVD, the above spindle motors are widely used as driving devices. In addition, in mirror drive devices such as laser printers, the above spindle motors are used as driving devices. In the above spindle motors, ball bearings were widely used as bearings, but they had limitations in rotation accuracy, high speed, and being able to produce little noise. Therefore, non-contact types of fluid dynamic pressure bearings which are superior in the above characteristics have been used.

In the fluid dynamic pressure bearings, an oil film composed of lubricating oil is formed in a small gap between a shaft and the bearing, and the oil film is compressed by rotating the shaft, so that the shaft is supported with high rigidity. The fluid dynamic pressure is effectively generated at recesses mainly comprising grooves formed on the shaft or the bearing. The bearings for spindle motors are structured such that a thrust load and a radial load are supported. The recesses for generating fluid dynamic pressure are formed on an end surface (a thrust surface) for supporting a thrust load and on an inside peripheral surface (a radial surface) for supporting a radial load. Sintered bearings are preferably used as the fluid dynamic pressure bearings since the sintered bearings can contain lubricating oil so as to supply lubricating oil to themselves, the above recesses for generating fluid dynamic pressure are easily formed, and the sintered bearings are superior in mass production thereof.

The sintered bearing are a sintered compact (porous body) having pores into which lubricating oil is impregnated, wherein the sintered compact is obtained by compacting a metal powder into a green compact and sintering the green compact. The sintered bearing is used in the above condition in which the lubricating oil is impregnated into the pores. The lubricating oil is exuded from the sintered bearing, and an oil film thereof is formed in a small gap between the bearing and a shaft in the above manner. The lubricating oil entering into recesses for generating fluid dynamic pressure is compressed in accordance with rotation of the shaft so as to support the shaft with high rigidity. The recesses for generating fluid dynamic pressure are formed by performing plastic working on a sintered bearing material.

Methods for forming thrust recesses for generating fluid dynamic pressure by plastic working are performed on materials other than the sintered bearing material. For example, thrust recesses for generating thrust fluid dynamic pressure are formed as described below. That is, in repressing a bearing material, for example, performing sizing or coining on a bearing material, a punch surface of a punch is faced on a thrust surface of the bearing material, wherein the punch surface has protrusions formed on the punch surface. Then, the bearing material is pressed by the punch in an axial direction, and the protrusions are pressed on the bearing material. As a result, the thrust recesses are formed. This method for forming the thrust recesses is disclosed in Japanese Unexamined Patent Application Publication No. Hei 5-60127.

In the case in which the above fluid dynamic pressure bearing is used for a spindle motor, the amount of the lubricating oil supplied to small gaps for generating fluid dynamic pressure is decreased more in the condition in which the motor is stopped, compared to the condition in which the motor is rotating, the small gaps being formed between a thrust surface and a shaft and between a radial surface and a shaft. Therefore, in the case in which rotation speed of the motor is relatively low in start-up of the motor and in stopping of the motor, the supply amount of the lubricating oil is insufficient. Due to this, friction of the shaft and the bearing is relatively large, so that metal contact easily occurs therebetween. In particular, since a load on a thrust side is larger than that on a radial side, this problem is notably caused on the thrust side. As a result, start-up of rotating the motor is slow, and lifetime of the fluid dynamic pressure bearing decreases.

### SUMMARY OF THE INVENTION

Therefore, an object of the present invention is to provide a fluid dynamic pressure bearing in which friction of the bearing and a shaft which easily occurs in start-up or in stopping of rotation of a motor can be prevented. An object of the present invention is to provide a fluid dynamic pressure bearing in which start-up of rotating a motor is thereby rapid. An object of the present invention is to provide a fluid dynamic pressure bearing of which lifetime increases. And an object of the present invention is to provide a production method for the above fluid dynamic pressure bearing.

According to one aspect of the present invention, a fluid dynamic pressure bearing composed of a cylindrical sintered compact includes: a thrust region which is formed on an end surface of the bearing and receives at least a thrust load; a roughed portion having small peaks and valleys formed on the thrust region; and thrust recesses for generating thrust fluid dynamic pressure, which are formed on the thrust region. The roughed portion may preferably have a surface roughness of 0.5 to 3 μm.

According to the above fluid dynamic pressure bearing of the present invention, the above thrust region is set on a portion which faces a thrust surface of a shaft of a spindle motor rotatably supported by the fluid dynamic pressure bearing. As a result, when lubricating oil is supplied to a small gap therebetween and the shaft is rotated, the lubricating oil supplied to the thrust recesses is at high pressure, so that thrust fluid dynamic pressure is generated.

According to the above fluid dynamic pressure bearing of the present invention, a portion on the above thrust region other than the thrust recesses is formed to have the roughed portion having small peaks and valleys so as to be uneven. Lubricating oil is easily held in the valleys of the roughed portion which function as oil reservoirs. Therefore, in rotation start-up of or rotation stopping of the shaft, a large amount of the lubricating oil exists between the thrust region of the end surface and the thrust surface of the shaft, so that friction of the thrust region and the thrust surface is inhibited, and wear thereof is inhibited.

According to a preferred embodiment of the present invention, the thrust recesses may be plural spiral grooves or plural herringbone grooves. The spiral grooves may extend so as to inwardly curve toward one circumferential direction of the end surface, and the herringbone grooves may have V-shaped portions which are aligned toward the one circumferential direction of the end surface.

According to another aspect of the present invention, a production method for a fluid dynamic pressure bearing includes: a punch having a punch surface having protrusions formed thereon; and pressing the protrusions of the punch surface on an end surface of a cylindrical sintered bearing material, the end surface having a thrust region for receiving at least a thrust load, so that thrust recesses are formed on the thrust region of the end surface, wherein the protrusions on the punch surface are formed by electric discharge working or chemical etching, and a roughed portion having small peaks and valleys is formed on surfaces proximate to the protrusions.

According to the above production method of the present invention, the protrusions on the punch surface are formed by electric discharge working or chemical etching, and the roughed portion having small peaks and valleys are formed on portions removed for forming the protrusions, that is, recesses (a surface proximate to the protrusions). When the punch surface having the roughed portion is abutted to the end surface of the sintered bearing material, the protrusions are pressed on the thrust region of the end surface. As a result, the thrust recesses are formed on the thrust region, and pattern of the roughed portion of the punch is transferred to the thrust region, so that a roughed portion having small peaks and valleys is formed on the thrust region of the sintered bearing.

In the present invention, since the sintered bearing material (sintered compact) is a porous body, it is plastically deformed in the production of the sintered bearing. Therefore, the above transfer of the pattern of the roughed portion of the punch can be easily performed.

In a preferred embodiment of the present invention, the punch may be composed of a material which can be subjected to electric discharge working or chemical etching. An alloy steel tool, for example, an alloy steel tool for cold working mold, an alloy steel tool for hot forming mold, and a high speed tool steel, and a cemented carbide are used as the material.

In production of the punch of another aspect of the present invention, formation of the protrusions on the punch surface and formation of the roughed portion on the surface (recesses on the punch surface) proximate to the protrusions can be simultaneously performed, so that the roughed portion can be formed on the recesses of the punch surface without increasing production processes. The roughed portion can be preferably small for making the thrust region be uneven, wherein the thrust region is on the end surface of the fluid dynamic pressure bearing. The end surface of the sintered bearing material can be pressed by the punch, so that formation of the thrust recesses and formation of the roughed portion on the thrust region of the end surface can be simultaneously performed. Therefore, the roughed portion can be formed on the end surface of the fluid dynamic pressure bearing without increasing production processes.

In the preferred embodiment of the present invention, although the protrusions on the punch surface of the punch are formed by electric discharge working or chemical etching, electric discharge working is preferably used. In the case in which the protrusions on the punch surface of the punch are formed by electric discharge working, the protrusions on the punch surface of the punch can be formed to have sharp edges, so that edges of the thrust recesses for generating thrust fluid dynamic pressure can be formed sharp by pressing the protrusions of the punch surface on the thrust region of the fluid dynamic pressure bearing. As a result, the thrust region of the fluid dynamic pressure bearing can have a desired shape.

According to a preferred embodiment of the present invention, the sintered bearing material is preferably made of a sintered alloy including 40 to 60 mass % of Fe, 40 to 60 mass % of Cu, and 1 to 5 mass % of Sn.

According to one aspect of the fluid dynamic pressure bearing, the end surface receiving a thrust load is formed to have the roughed portion having small peaks and valleys so as to be even, so that the valleys of the roughed portion function as oil reservoirs. Therefore, in rotation start-up of or rotation stopping of the shaft, a large amount of the lubricating oil exists between the upper end surface and the shaft, and friction of the thrust region of the end surface and the thrust surface of the shaft is thereby inhibited. As a result, rotation start-up of the motor is rapid, and the fluid dynamic pressure bearing can have a long lifetime.

### BRIEF DESCRIPTION OF THE DRAWINGS

FIG. 1 is a longitudinal cross sectional view of a fluid dynamic pressure bearing of the embodiment according to the present invention.

FIG. 2 is an enlarged view of a portion indicated by an arrow II in FIG. 1.

FIG. 3 is a top view of a fluid dynamic pressure bearing of the embodiment.

FIG. 4 is a cross sectional view viewed in a direction of arrow line IV-IV in FIG. 1.

FIG. 5 is a side view showing the condition in which a sintered bearing material is pressed by a repressing die so that spiral grooves are formed on an upper end surface thereof.

FIG. 6 is a side view showing an upper punch for repressing and a sintered bearing material which is pressed by the upper punch.

FIG. 7 is a side view showing the condition in which separation grooves and circular arc surfaces are formed on an inside peripheral surface of a sintered bearing material by a working apparatus for working an inside peripheral surface.

FIG. 8 is a top view of a fluid dynamic pressure bearing showing another embodiment of thrust recesses (herringbone grooves).

FIGS. 9A to 9E are diagrams showing the relationship of surface roughness of a thrust surface and start-up friction torque measured in the example.

### DESCRIPTION OF THE PREFERRED EMBODIMENTS

An embodiment of the present invention will be described hereinafter with reference to the drawings.

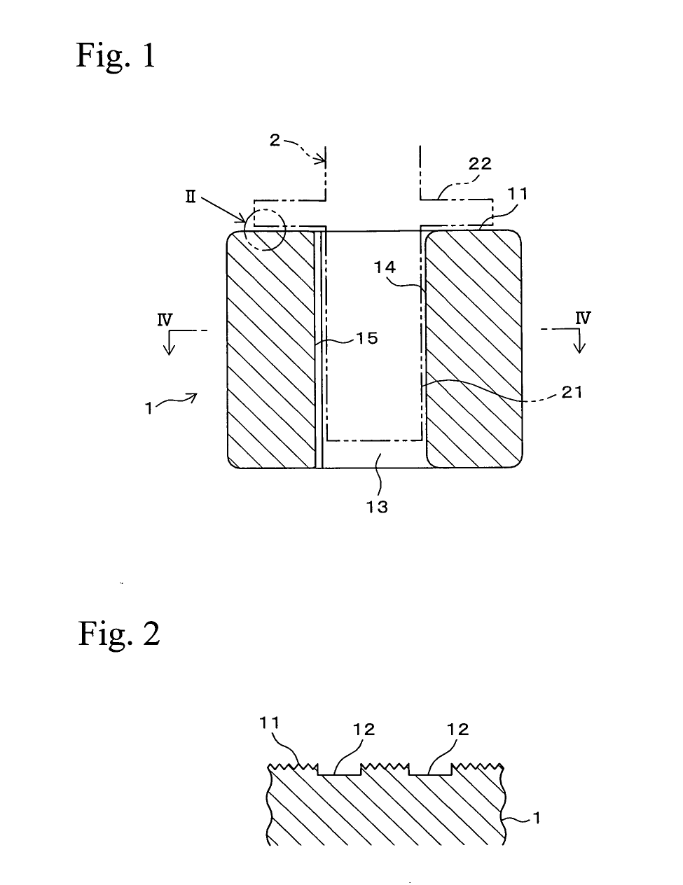

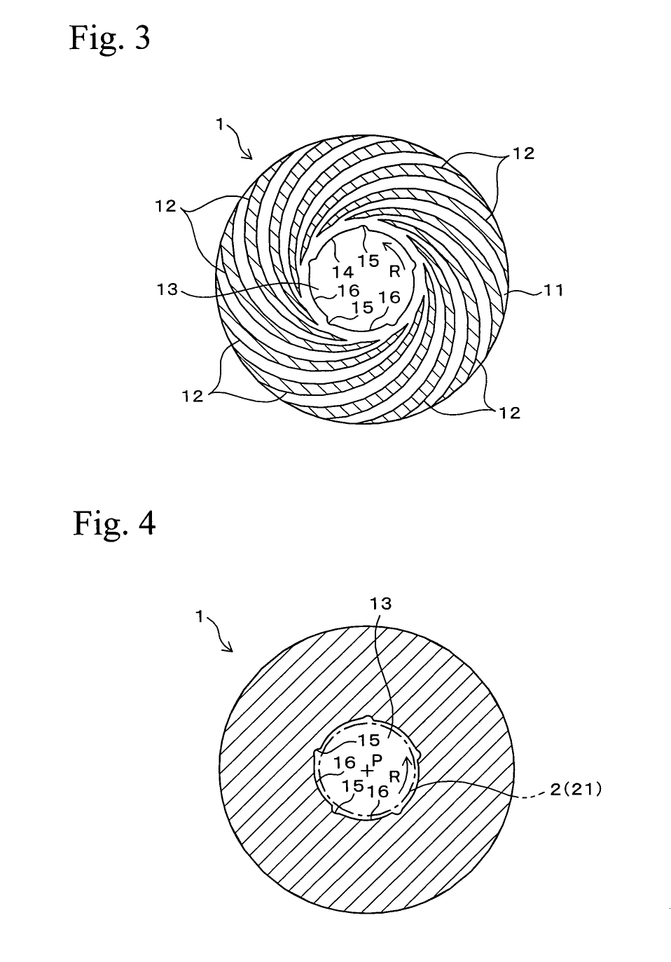

FIG. 1 shows a cylindrical fluid dynamic pressure bearing 1 of the embodiment according to the present invention. FIG. 2 is an enlarged view of a portion indicated by an arrow line II in FIG. 1. FIG. 3 is a top view of the fluid dynamic pressure bearing 1. FIG. 4 is a cross sectional view viewed in a direction of arrow line IV-IV in FIG. 1. Reference numeral 2 in FIGS. 1 and 4 denotes a shaft rotatably supported by the fluid dynamic pressure bearing 1.

As shown in FIG. 2, a roughed portion having small peaks and valleys is formed on an overall end surface (upper surface in FIG. 1) 11 of the fluid dynamic pressure bearing 1. The upper surface 11 is the roughed portion having small peaks and valleys. The surface roughness of the upper surface 11 is preferably 0.5 to 3 μm.

On the upper surface 11 formed with the roughed portion in the above manner, as shown in FIG. 3, plural (in this case, 12) spiral grooves 12 are formed at equal intervals in one circumferential direction. The spiral grooves 12 extend so as to inwardly curve toward a rotation direction R of the shaft 2. End portions on peripheral sides of the spiral grooves 12 open to a peripheral surface, but end portions on inside peripheral sides of the spiral grooves 12 do not open to an inside peripheral surface 14 of a shaft hole 13 so as to close. The upper surface 11 of the fluid dynamic pressure bearing 1 is a thrust surface for receiving a thrust load from a shaft 2, and the spiral grooves 12 are thrust recesses for generating thrust fluid dynamic pressure.

As shown in FIG. 4, plural (in this case, 5) separation grooves 15 are formed at equal interval on the inside peripheral surface 14 of the dynamic pressure bearing 1. The separation grooves 15 are semi-circular arc-shaped in cross section, and extend straight from one end surface to the other end surface in an axial direction. Circular arc surfaces 16 are formed between the respective separation grooves 15 of the inside peripheral surface 14. Centers of the circular arc surfaces 16 are eccentric with respect to an axial center P of an outside diameter of the fluid dynamic pressure bearing 1. The circular arc surfaces 16 are inwardly biased toward the rotation direction R of the shaft 2. The inside peripheral surface 14 of the fluid dynamic pressure bearing 1 is a radial surface for receiving a radial load from the shaft 2. The circular arc surfaces 16 are radial recesses for generating radial fluid dynamic pressure.

The above circular arc surfaces 16 are eccentric with the outer diameter of the fluid dynamic pressure bearing 1, and the centers of the respective circular arc surfaces 16 exist at equal intervals in the circumferential direction around the axial center P so as to be concentric with respect to the axial center P. The small gap between the each circular arc surface 16 and the outside peripheral surface of the shaft 2 is wedge-shaped in cross section so as to be narrower and smaller toward the rotation direction of the shaft 2 in accordance with the above shape of each circular arc surface 16.

As shown in FIG. 1, the shaft 2 has a shaft body 21 and a thrust washer 22 fit into the shaft body 21. The shaft body 21 is inserted into the shaft hole 13 of the fluid dynamic pressure bearing 1 from the upper side in the Figure, and the thrust washer 22 is disposed to face the upper end surface 11. A radial load of the shaft 2 is received by the inside peripheral surface 14 of the fluid dynamic pressure bearing 1, and a thrust load of the shaft 2 is received by the upper end surface 11 of the fluid dynamic pressure bearing 1. An outside diameter of the thrust washer 22 is slightly smaller than that of the fluid dynamic pressure bearing 1, and a portion (thrust region) of the fluid dynamic pressure bearing 1 for receiving a thrust load of the shaft 2 is a portion on the upper end surface 11 facing the thrust washer 22.

For example, the fluid dynamic pressure bearing 1 of the embodiment is used for spindle motors for hard disc drive devices. In this case, a magnetic disc is installed on a portion higher than the thrust washer 22 of the shaft body 21 via a rotor hub.

The fluid dynamic pressure bearing 1 is a sintered bearing formed by compacting a raw powder into a green compact and sintering the green compact. A production method therefor will be explained hereinafter.

(1) Compacting process of raw powder and sintering process of green compact

A Fe powder and a Cu powder, etc. are mixed as a raw powder at an appropriate mixing ratio thereof, so that a mixed powder is obtained. The mixed powder is filled in a compacting die, and then is compacted into a green compact therein, wherein the green compact has a shape similar to that of a fluid dynamic pressure bearing 1 which is subsequently produced. The green compact is sintered by heating it to a predetermined temperature and for a predetermined time which are determined in accordance with the raw powder. As a result, a cylindrical sintered bearing material is obtained. The above raw powder is preferably used in which an Fe powder, a Cu powder, and a Sn powder are contained, the amount of Fe being nearly equal to the amount of Cu, and the amount of Sn being a few mass %. For example, the amount of Fe is 40 to 60 mass %, the amount of Cu is 40 to 60 mass %, and the amount of Sn is 1 to 5 mass %.

In the above composition, an alloy composed of a soft Cu—Sn alloy phase and a high-strength Fe alloy phase is obtained after the sintering. As a result, initial running of the motor takes a short time due to the soft phase, and the time for initial running and wear resistance of the sintered bearing can be well-balanced. The sintered bearing can have strength required in press-fitting a sintered bearing into a housing, and plastic workability required in forming grooves for generating fluid dynamic pressure.

(2) Working of Sintered Bearing Material

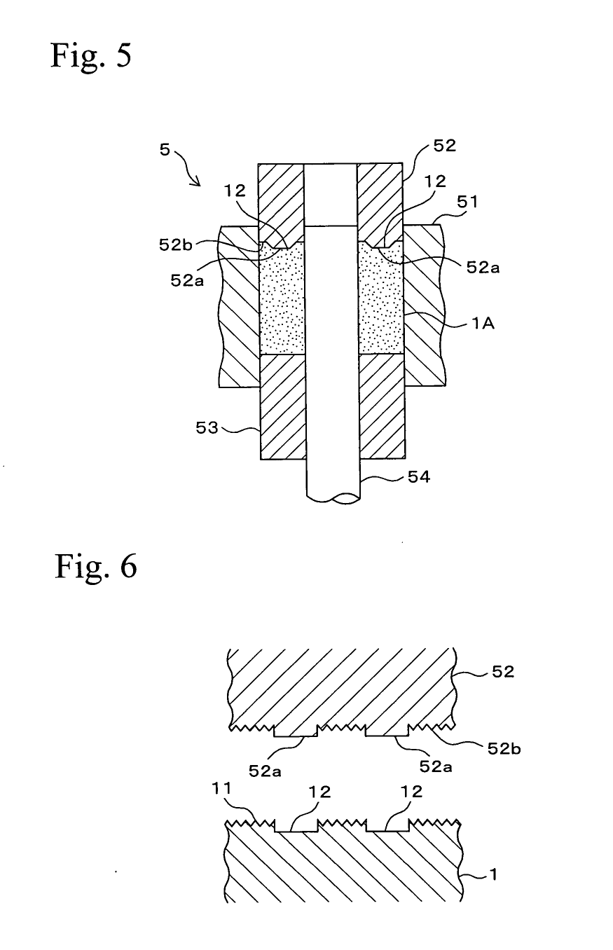

As shown in FIG. 5, a repressing die 5 for sizing or coining is prepared. The repressing die has a die 51, upper and lower punches 52 and 53, and a core rod 54. The upper punch 52 is a punch having plural protrusions 52a formed on a punch surface 52b which is a lower end surface, wherein the plural protrusions 52a are for forming spiral grooves 12. The protrusions 52a are formed by electric discharge working or chemical etching. A roughed portion having small peaks and valleys is formed on a punch surface 52b other than the protrusions 52a by this forming method for the protrusions 52a. The punch surface 52b has surface roughness of 0.5 to 3 μm.

As shown in FIG. 5, the sintered bearing material 1A is set in the repressing die 5, and is pressed by the upper and lower punches 52 and 53 in an axial direction. In this repressing process, the upper punch 52 compresses the upper surface 11 of the sintered bearing material 1A, so that the spiral grooves 12 are formed by pressing the protrusions 52a on the upper surface 11. As shown in FIG. 6, the rough punch surface 52b is simultaneously transferred to protrusions of upper surface 11 (portions other than the spiral grooves 12), so that a roughed portion having small peaks and valleys is formed thereon. In this case, the sintered alloy having the above composition is used as the sintered bearing material 1A, pattern of the punch surface 52b is transferred to the protrusions on the upper surface 11 of the sintered bearing material 1A so as to have the same roughness as that of the punch surface 52b. Therefore, the sintered alloy is preferably used.

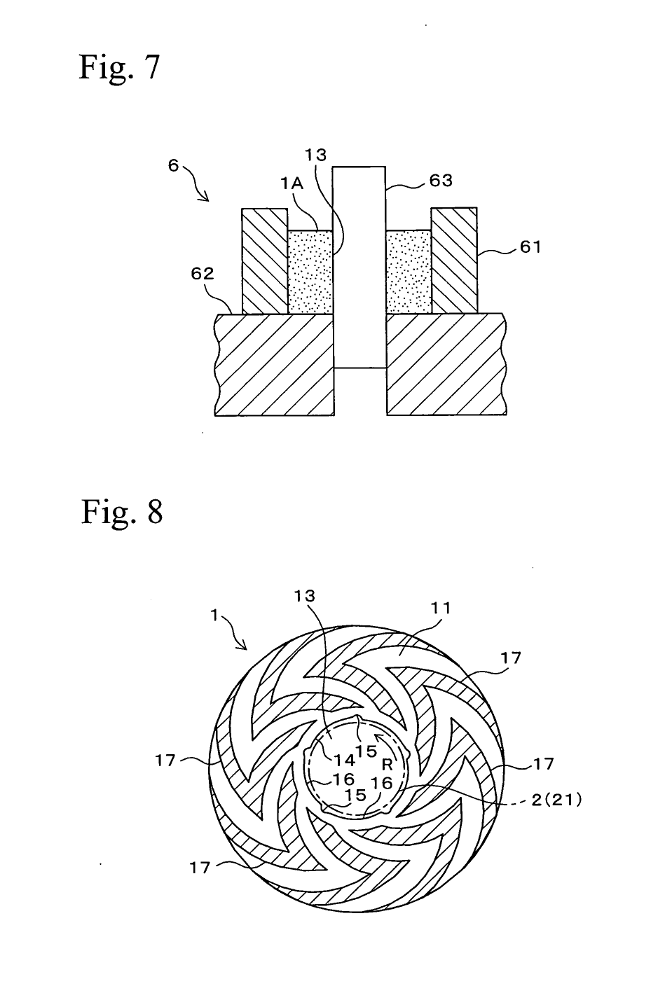

In the fluid dynamic sintered bearing of the present invention, recesses for generating fluid dynamic pressure may be formed on the inside peripheral surface (radial surface). For example, the recesses having multi-circular arc shapes can be formed as described below. That is, FIG. 7 shows an inside peripheral working apparatus 6 having upper and lower dies 61 and 62, and a pin 63 which has protrusions for forming separation grooves and circular arc surfaces. In the inside peripheral working apparatus 6, the upper die 61 is mounted on the lower die 62 which is secured, and the sintered bearing material 1A having spiral grooves 12 formed in the same manner is fit into the upper die 61. Then, the pin 63 is press-fit into the shaft hole 13 of the sintered bearing material 1A from the upper side thereof, so that separation grooves 15 and circular arc surfaces 16 are formed on the inside peripheral surface 14 by the protrusions of the pin 63.

After that, the pin 63 is removed from the sintered bearing material 1A, and the sintered bearing material 1A is removed from the upper die 61, so that the fluid dynamic pressure bearing 1 is obtained, wherein the fluid dynamic pressure bearing 1 has the spiral grooves 12 formed on the upper surface 11, and has the separation grooves 15 and the circular arc surfaces 16 formed on the inside peripheral surface 14. In this manner, in the fluid dynamic pressure bearing 1, the radial recesses can be used if necessary. The radial recesses may be formed to be herringbone-shaped instead of being multi-circular arc-shaped.

In the fluid dynamic pressure bearing 1 of the present invention, lubricating oil is impregnated into the fluid dynamic pressure bearing 1, so that the fluid dynamic pressure bearing 1 is used as an oil-impregnated bearing. The shaft 2 inserted into the shaft hole 13 is rotated in the direction of arrow line R as shown in FIGS. 3 and 4, the lubricating oil is exuded to the respective separation grooves 15 of the inside peripheral surface 14, and is held therein. The lubricating oil held therein is efficiently moved by the shaft 2, and enters into the wedge-shaped small gap between each circular arc surface 16 and the shaft 2, so that an oil film is formed. The lubricating oil entering the small gap flows to the narrower and smaller side of the small gap, and thereby is under high pressure due to the wedge effect, so that a high radial dynamic pressure is generated. Portions under high pressure in the oil film are generated at equal intervals in the circumferential direction in accordance with the shapes of the circular arc surfaces 16. As a result, a radial load of the shaft 2 is supported with high rigidity in a well-balanced manner.

On the other hand, the lubricating oil is exuded to the respective spiral grooves 12 formed on the upper end surface 11 of the fluid dynamic pressure bearing 1, and is held therein. One portion of the lubricating oil held therein is moved from the respective spiral grooves 12 by the rotation of the shaft 2, so that an oil film thereof is formed between the upper end surface 11 and the thrust washer 22. The lubricating oil held in the respective spiral grooves 12 flows from the peripheral side to the inside peripheral side, so that thrust dynamic pressure is generated, and is highest at an end portion on the inside peripheral side. The thrust dynamic pressure is received by the thrust washer 22, so that the shaft 2 is floated by a small amount. As a result, a thrust load is supported with high rigidity in a well-balanced manner.

According to the fluid dynamic pressure bearing 1 of the embodiment, the upper end surface 11 receiving a thrust load is formed to have the roughed portion having small peaks and valleys so as to be even, so that lubricating oil is easily held in the valleys of the roughed portion which functions as oil reservoirs. Therefore, in start-up of or stopping of the spindle motor, a large amount of the lubricating oil exists between the upper end surface 11 and the shaft 2, and friction of the upper end surface 11 and the shaft 2 is thereby inhibited. As a result, rotation start-up of the motor is rapid. Wear of the upper end surface 11 and the shaft 2 is inhibited, so that the fluid dynamic pressure bearing 1 can have a long lifetime.

In the repressing process, the upper end surface 11 of the fluid dynamic pressure bearing 1 becomes rough, and the spiral grooves 12 are simultaneously formed on the upper surface 11, so that a process for making the upper end surface 11 be rough is not required to separate, and the production method of the embodiment is effective. Since the protrusions 52a are formed by electric discharge working or chemical etching, the punch surface 52b of the upper punch 52 is rough, the surface of the fluid dynamic pressure bearing can be formed effectively. The roughed portion formed by the upper punch 52 in the above manner is preferably small.

In the above embodiment, although the roughed portion having small peaks and valleys is formed on the overall upper end surface 11 other than the spiral grooves 12, in order to sufficiently obtain the effects of the present invention, the roughed portion may be formed on at least the thrust region which faces on the thrust washer 22 of the shaft 2, wherein friction of the thrust region and the thrust washer 22 is generated.

Plural herringbone grooves 17 shown in FIG. 8 may be used as the thrust recesses instead of the spiral grooves 12 shown in FIG. 3. The herringbone grooves are formed at equal intervals in the circumferential direction. The herringbone grooves have V-shaped portions which are aligned toward the rotation direction R of the shaft 2. Each herringbone groove 17 is structured so as to curve inwardly toward the rotation direction R of the shaft 2, wherein although an end portion on the peripheral side thereof opens to the peripheral surface in the same manner as each spiral groove 12, an end portion on the inside peripheral side opens to an inside peripheral surface 14 of the shaft hole 13.

### EXAMPLES

Next, examples of the present invention will be explained, and the effects of the present invention will be confirmed.

49 mass % of Cu powder, 49 mass % of Fe powder, and 2 mass % of Sn powder were mixed into a raw powder, the raw powder was compacted into a green compact, and the green compact was sintered into a sintered compact, so that the required number of cylindrical sintered bearing materials was obtained. The sintered bearing materials had a density of 6.3 to 7.2 Mg/m³, an outside diameter of 6 mm, an inside diameter of 3 mm, and an axial direction length of 5 mm. Punches were produced by electronic discharge working so as to have punch surfaces having depth of 10 g/m, wherein respective roughness of the punch surface was different from each other. The punches were repressed on end surfaces of the above sintered bearing materials. As a result, a roughed portion having small peaks and valleys was formed on bearing end surfaces which are thrust surfaces, and spiral grooves shown in FIG. 3 were formed thereon.

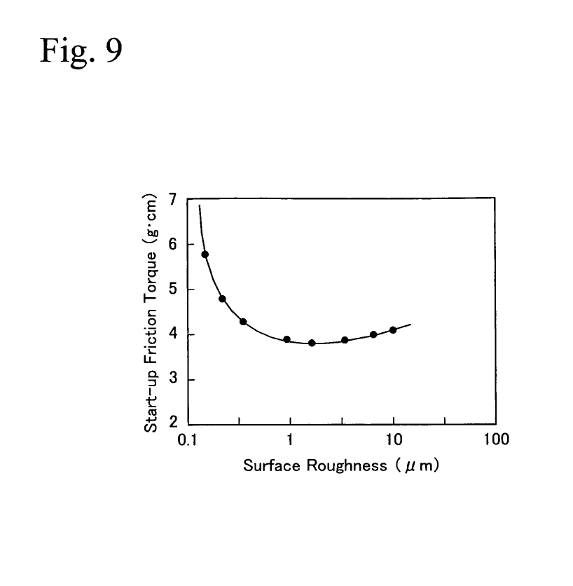

Next, the shaft was rotatably supported by each fluid dynamic pressure bearing in the condition as shown in FIG. 1, and each start-up friction torque was measured when rotating the shaft. FIG. 9 shows the measured results. According to the measured results, in the roughness of the bearing end surface of from 0.5 to 10 μm, the start-up friction torque is stably low. Therefore, it was confirmed that the start-up friction torque is reduced by forming the roughed portion having small peaks and valleys on the bearing surface. On the other hand, the dynamic pressure effects regarding the above fluid dynamic pressure bearings were measured. As a result, the thrust floating amount is about 5 μm in normal rotation of the shaft. In contrast, in the case in which the surface roughness of the bearing end surface exceeded 3 μm, sufficient thrust amount cannot be obtained, and the bearing and the shaft made contact. It was confirmed that the surface roughness of the fluid dynamic pressure bearing surface was preferably 0.5 to 3 μm according to the results of the start-up friction torque and the floating properties.

What is claimed is:

1. A production method for a fluid dynamic pressure bearing, comprising:
a punch having a punch surface having protrusions formed thereon; and
pressing the protrusions of the punch surface on an end surface of a cylindrical sintered bearing material, the end surface having a thrust region for receiving at least a thrust load, so that thrust recesses are formed on the thrust region of the end surface,
wherein the protrusions on the punch surface are formed by electric discharge working or chemical etching, and a roughed portion having small peaks and valleys is formed on surfaces proximate to the protrusions on the punch surface.

2. The production method for a fluid dynamic pressure bearing according to claim 1, wherein the sintered bearing material is made of a sintered alloy including 40 to 60 mass % of Fe, 40 to 60 mass % of Cu, and 1 to 5 mass % of Sn.
